(19) United States
(12) Patent Application Publication
(10) Pub. No.: US 2026/0233465 A1
(43) Pub. Date: Aug. 13, 2026

(54) METHOD AND SYSTEM FOR ELONGATING VOXEL IN MULTIPHOTON FABRICATION

(71) Applicant: UAB VITAL3D TECHNOLOGIES, Vilnius (LT)

(72) Inventor: Linas JONUŠAUSKAS, Vilnius (LT)

(21) Appl. No.: 19/151,785

(22) PCT Filed: Jan. 31, 2023
(86) PCT No.: PCT/IB2023/050832

§ 371 Date: Jul. 29, 2025

(51) Int. Cl. B29C 64/386; B29C 64/135; B29C 64/273; B29C 64/286; B33Y 10/00; B33Y 30/00; B33Y 50/00

(52) U.S. Cl. CPC B29C 64/386; B29C 64/135; B29C 64/273; B29C 64/286; B33Y 10/00; B33Y 30/00; B33Y 50/00

(57) ABSTRACT

A method of elongating voxel includes-importing 3D model and slicing or otherwise turning into fabrication suitable movement pattern;-determining via software what parts of structure requires high resolution and which needs to be filled completely; —using a femtosecond laser source based multiphoton setup to emit ultrashort pulse, with duration from 40 fs to 10 ps, repetition rate from 1 kHz to 500 MHz, wavelength from 380 nm to 2000 nm and diameter from 1 mm to 10 mm; —using a beam shaping element to generate masks for volume filling to each translation during fabrication resulting in elongated voxel in focal plane of focusing element; —during fabrication, positioning system is translating sample while beam shaping element is projecting mask needed to generate spatial distribution appropriate for that particular segment of the printed structure. Also a system for elongating voxel according to the method.

### FIELD OF THE INVENTION

The invention relates to the field of 3D printing, in particular to a multiphoton polymerization (MPP) based femtosecond laser 3D printer with elongated voxel.

### DESCRIPTION OF THE RELATED ART

3D printing, a process known as additive manufacturing, utilizes a digital 3D model to fabricate a physical object through the successive layering of materials. One of the main challenges in 3D printing is finding the right balance between printing resolution, or the level of detail that can be achieved in the final object, and throughput, or the speed at which the object can be printed.

There are several different techniques for 3D printing, each with its own trade-offs in terms of resolution and throughput. Fused deposition modeling (FDM) and injection printing are examples of techniques that are capable of achieving high throughput, with rates of up to cm3/min. These techniques work by extruding a stream of molten material onto a build platform, layer by layer, to create the final object. While they can produce objects quickly, the resolution is often limited, with feature sizes on the order of several tens to hundreds of micrometers or more. On the other hand, techniques such as MPP can achieve much higher resolutions, down to the micron or nanometer scale. This is done by using focused lasers to precisely cure small volumes of resin, building up the object layer by layer. However, these techniques are typically much slower than FDM or injection printing, with throughputs on the order of pm3/s or less.

As a result, there is a desire for an approach that can combine both high throughput and high resolution. While some progress has been made in this area, it is still an active area of research and development, with no single approach that has emerged as a clear leader. Some possibilities for achieving this combination include combining different 3D printing techniques, such as using FDM for fast, low-resolution parts of an object and switching to MPP for high-resolution details or developing new techniques that can achieve both high throughput and high resolution simultaneously. A solution, which accomplishes aforementioned properties is necessary.

The patent document CN 105751511 A (published on 13 Jul. 2016) provides a 3D printer and printing method that utilizes two-photon polymerization to allow for micro-nano scale printing. It involves adjusting the appropriate print start position, generating a control code for the model slice to be printed, and controlling the motion platform and the objective lens to move according to a predetermined trajectory while also controlling the optical path switch to expose the photosensitive resin at a suitable position to cause polymerization and solidification. The uncross linked photosensitive resin is then dissolved after the printing is completed. The 3D printer and printing method allow for the creation of sub-micron structures, which is not possible with common 3D printing techniques. However, the miniature scale of the structures being fabricated through 3D printing using this technology is a limiting factor. The laser's ability to concentrate on minute areas renders it inadequate for printing larger structures with the same level of precision. While this technology is proficient in producing small, intricate structures with a high degree of detail, it is not suitable for printing larger structures with a comparable level of resolution and speed.

In WO2022088533A1 (published on 5 May 2022), a device variant relates to the fractional Fourier holographic femtosecond laser three-dimensional parallel processing system. It uses a spatial light modulator (SLM) to receive a femtosecond laser beam and a fractional Fourier hologram and emit a series of modulated light beams to multiple focusing planes. This structure is utilized to improve the processing quality and efficiency of a three-dimensional distribution micro structure and increase the accuracy of the inter-structure position in three-dimensional distribution. One major drawback is the increased complexity of the system. With multiple focal points, the printer needs to be able to accurately control the movement and alignment of each independently, which can be challenging.

An alternative technology of 3D printing is described in patent document Nr. US 11085018B2 (published on 10 Aug. 2021) whereby the methods and systems for forming a three-dimensional object corresponding to an organ or organoid are provided. This technique involves using lasers to create microstructures at sub-nanometer resolutions, which can be used to create micrometer-to-nanometer-scale parts and tools through a process called additive manufacturing. The high-resolution and low toxicity of multi-photon excitation make it a suitable tool for polymerization in tissue engineering, allowing for the creation of functional capillaries and vascularized tissue-engineered devices. Thus, this 3D printer technology is only optimized and limited to printing biological matter.

In KR20170073447A (published on 28 Jun. 2017), invention relates to a laminated three-dimensional (3D) printer that utilizes a hologram to rapidly produce a 3D printing result in a photocurable medium. The hologram is being generated based on image information and reproduces it on the photocurable medium, causing it to cure according to the shape of the hologram. The optical system of the 3D printer is capable of controlling the size and position of the hologram through the use of a view window generation method. This allows for the efficient production of 3D printing results in a short period of time. Although fast, this method of printing has low rate due to its high-speed manufacturing. In addition, the resins available for the cationic photopolymerization are limited.

A similar technique of 3D printing by using femtosecond laser paired with spatial light modulator has been discussed and investigated in patent document Nr. CN209756092U (published on 10 Dec. 2019). The utility model discloses a two-photon 3D printer capable of switching printing modes: point-by-point scanning printing module which obtains higher resolution and surface exposure printing module which provides high throughput. Although, this system optical chain is capable of achieving high throughput and resolution, its two-module structure is complex and have more potential points of failure that must be addressed than for instance typical one-module printer.

Accordingly, it is desired to provide an improved 3D printer.

This description provides a concept of 3D printer which involves the use of a femtosecond laser in combination with a beam shaping element, preferably SLM, to dynamically alter the shape of voxel, which is small three-dimensional unit of volume, in the XY plane and potentially also in the Z direction as needed. This would allow for an increase in throughput, or the amount of work that can be completed in a given period of time, by allowing for the efficient manipulation of the voxel for a specific task. Additionally, the ability to revert to using unstructured light can enable the creation of the smallest possible voxel for highly precise part fabrication, or the manufacturing of components or devices. This approach has the potential to greatly improve efficiency and accuracy in various applications such as additive manufacturing, microfabrication, and more.

### SUMMARY OF THE INVENTION

The proposed system uses a femtosecond laser-based MPP setup in conjunction with a beam shaping element, rather SLM, to elongate voxel for increased throughput and precision in part fabrication. The SLM works on the principle of generating a phase mask, which acts as a hologram, allowing for the generation of nearly arbitrary intensity distributions at the focal plane of a focusing optic, such as a lens or objective. The beam shaping element can be used in a 4F system or placed in the back focal plane of the focusing optic.

An elongated voxel is created to fill-in inside of a structure during the hatching process. A software based on the Gerchberg-Saxton algorithm or other appropriate calculation methodology is used to generate the appropriate phase mask for this task. When smaller features are present within a printed structure, these are finished using the smallest possible voxel, which is acquired without any light structuring. The software is used to determine the exact width of the brush and when it should be turned, it can be turned 360° along the Z/optical axis depending on the required translation direction. The voxel can also assume various different shapes, such as a double brush with a gap somewhere in the brush, an X-shaped brush which should act as a translation direction-independent brush, or a brush consisting of multiple focal points aligned in a line, which would result in a structure made out of multiple lines spaced apart.

Additionally, the objective and the whole optical chain can be stationary or moving during the whole process, and printing is preferably carried out using standard slicing and hatching procedure, i.e. in layer-by-layer fashion but is not fundamentally limited to it. In this way, the proposed system allows for increased flexibility and precision in the fabrication of parts.

### BRIEF DESCRIPTION OF DRAWINGS

FIG. 1: Shows the side view of elongated voxel.

FIG. 2: Top view of elongated voxel in focusing plane.

FIG. 3: Optical chain with reflection beam shaping device-DMD (Dynamic mirror device) or Spatial light modulator (SLM).

FIG. 4: Optical chain using DOE (Diffractive optical element) for beam shaping.

FIG. 5: Optical chain with transmission SLM (Spatial light modulator) used for beam shaping.

FIG. 6: Simplified schematic of optical chain.

### DETAILED DESCRIPTION OF THE INVENTION

The proposed invention represents a significant advancement in the field of additive manufacturing. Its unique ability to control the placement makes it valuable tool for bioprinting, allowing for the creation of functional tissue structures for use in research, drug development, and even transplants. In addition to its bioprinting capabilities, the elongated voxel 3D printer is also highly efficient in printing mechanical microstructures. Its precision and micron-level feature size capabilities make it ideal for applications such as microelectromechanical systems (MEMS), micro-optics, microfluidics, and lab-on-a-chip devices.

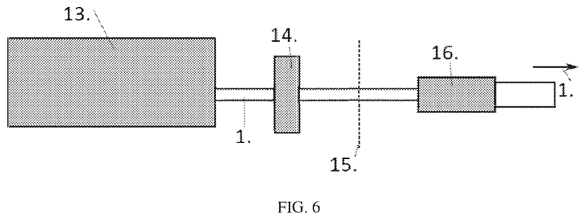

Voxel elongation uses general optical chain for preliminary beam control FIG. 6. The first component in the optical chain is ultrafast (femtosecond) laser (13). It emits femtosecond radiation, which is later attenuated power vise by power attenuator (14). This is necessary because the femtosecond laser (13) emits beam, which can be too powerful for certain applications. Polarization control optic (15) follows, which aligns the electric field of the light in a specific direction. Exact polarization requirement is dictated by that beam shaping device, but it can be elliptical, circular, or linear with specific orientation. The third component in the optical chain is a beam expander (16), which is used to adjust the size of the beam so that it matches the size of the beam shaping element or the matrix size of the device. Ensuring the beam has the correct size is crucial for the beam shaping device to operate correctly. All these components can be separated from the laser source or all or some of these elements can be integrated into laser source/system. Such optical chain which controls laser power, polarization and beam size is mandatory and similar for all the beam shaping systems.

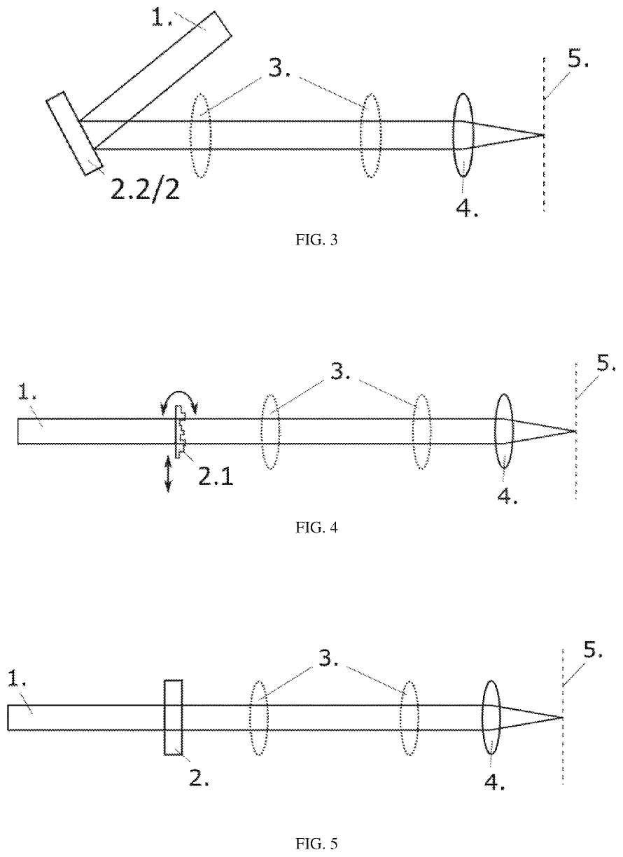

Voxel elongation can be realized using 3 distinct setups: optical chain with reflection beam shaping device-DMD or SLM FIG. 3, optical chain using DOE for beam shaping FIG. 4 and optical chain with transmission SLM used for beam shaping FIG. 5. Aforementioned shaping elements are quasi-stationary meaning that the condition or state is almost but not completely constant or unchanging. To make the setup work it is paired with femtosecond laser (13) which emits an ultrashort pulse, which can be characterized with duration from 40 fs to 10 ps, repetition rate from 1 kHz to 500 MHz, wavelength from 380 nm to 2000 nm and diameter—from 1 mm to 10 mm. Optional 4F system (3) consisting of two lenses for relaying shaped beam at distances longer than the focal distance of focusing optic which can be either regular lens or objective lens with NA: from 0.1 to 1.45.

In an optical chain that utilizes SLM (2) or DMD with reflection FIG. 3, the sequence of components begins with the beam shaping element. The SLM (2), an important component of the optical chain, modulates the phase laser beam by displaying a specific pattern (mask) on its surface that controls the phase of the light passing through it. If DMD (2.2) is used then the same effect is achieved via amplitude modulation. Although, it achieves lower quality compared to SLM (2). Created masks allow for the creation of complex beam profiles that are tailored to the specific requirements of the polymerization process. The 4F relay optics (3) (optional) are used to relay the beam from the SLM (2) or DMD (2.2) to the focusing element (4), using a set of lenses and mirrors to manipulate the beam's path and ensure proper alignment. The focusing element (4), objective lens with numerical aperture from 0.1 to 1.45, focuses the beam to a small spot size at the focal plane (5), where the polymerization process takes place. The optical chain allows the manipulation of the laser beam to achieve the desired intensity distribution at the focal plane (5) and thus creating an elongated voxel (6), designed to increase the precision of 3D printing. SLM (2) as well as DMD (2.2) matrix and beam size should be matched as close as possible within no more than 10% size difference.

In an optical chain that utilizes DOE (2.1) FIG. 4, the sequence of components and their functions are similar to those in an optical chain FIG. 3 that applies SLM (2) or DMD (2.2).

When a DOE (2.1) is used in the beam shaping part of the optical chain, a mechanical element is needed to adjust its orientation in relation to the laser beam. This changes orientation of elongated voxel (6) in focal plane (5). DOE (2.1) can also be mechanically removed to revert back to non-modified laser beam. Only one elongation size can be achieved in this case, as DOE (2.1) is not active device and can generate only one type of beam shaping. Its (2.1) size and beam size should be matched as close as possible within no more than 10% size difference.

When transmission SLM (2) is used in the optical chain FIG. 5 it also modulates the phase laser beam as reflective SLM (2) in the FIG. 3. However, transmission beam shaping element has lower contrast ratio. Apart from that, all 3 optical chains are homogeneous.

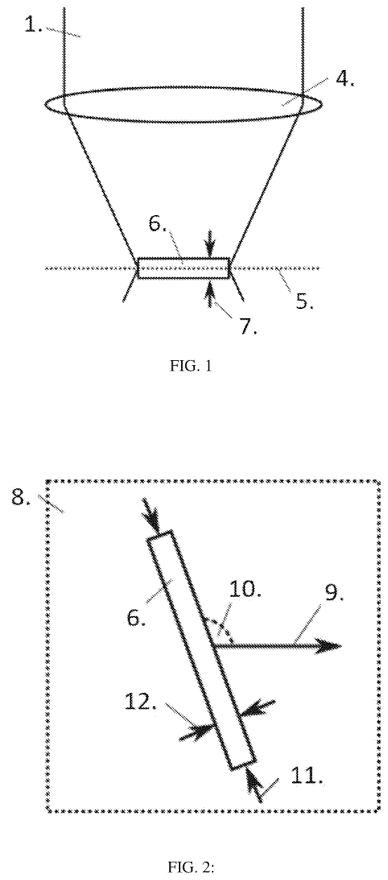

The configuration of an elongated voxel (6) in the focal plane (5) is shown in FIGS. 1 and 2. An elongated voxel (6) is created to fill-in inside of the structure during hatching process. The height of the formed elongated voxel (6) is determined by the focusing optic (4) being used. The focal width, or the width of the voxel (6), can be freely chosen and can range from the diffraction limited size to the working field width of the focusing optic (4). The thickness of the elongated voxel (6) should be from the diffraction limited size to a maximum of 10 times the wavelength () used for the fabrication. The voxel (6) is elongated at an angle, referred to as a, to the translation direction. This angle can range from 0 to 360 degrees. The elongation of the voxel can be symmetrical in relation to the optical axis or elongated to only one side.

The process of 3D printing using elongated voxel (6) begins with importing a 3D model and slicing it into a fabrication-suitable movement pattern. The software then identifies which parts of the structure require high resolution and which need to be filled completely. Next, masks for volume filling are generated and assigned to each translation during fabrication.

During the fabrication process, a positioning system, which can be mechanical stages, scanners, or a combination of both, translates the sample while the beam shaping device projects the appropriate mask for that particular segment of the printed structure. The software, based on the Gerchberg-Saxton algorithm or other calculation methodologies, generates the appropriate mask for the task. Smaller features within the printed structure are finished using voxel (6) acquired without any light structuring, resulting in the smallest possible voxel (6). The software also determines the exact width of the voxel (6) and when it should be turned, which can be 360 degrees along the Z/optical axis depending on the required translation direction. Voxel (6) can adopt in various shapes, such as a double with a gap, an X shape that is translation direction-independent, or a configuration of multiple focal points aligned in a line. The objective and the whole optical chain can be stationary or moving during the whole process. The printing is preferably carried out using a standard slicing and hatching procedure, that is, in a layer-by-layer fashion, but it is not fundamentally limited to it.

1. A method of elongating voxel, comprising:
importing 3D model and slicing or otherwise turning into fabrication suitable movement pattern;
determining via software what parts of structure requires high resolution and which needs to be filled completely;
characterized in that, it has the following steps:
using a femtosecond laser source based multiphoton setup to emit ultrashort pulse, with duration from 40 fs to 10 ps, repetition rate from 1 kHz to 500 MHz, wavelength from 380 nm to 2000 nm and diameter-from 1 mm to 10 mm; using a beam shaping element to generate masks for volume filling to each translation during fabrication resulting in elongated voxel (6) in focal plane of focusing element;
during fabrication, positioning system is translating sample while beam shaping element is projecting mask needed to generate spatial distribution appropriate for that particular segment of the printed structure.

2. The method of claim 1, wherein the beam shaping element used of the group comprising of:
a) Spatial light modulator (SLM);
b) Diffractive optical element (DOE);
c) Dynamic mirror device (DMD).

3. The method of claim 1, wherein voxel elongation manipulation occurs at focal plane of focusing optic.

4. The method of claim 1 wherein voxel can adopt in various shapes, such as a double with a gap, an X shape that is translation direction-independent, or a configuration of multiple focal points aligned in a line.

5. The method of claim 1 wherein formed elongated voxel height is controlled by the focusing optic.

6. The method of claim 1, wherein the thickness of elongated voxel should be limited to up to 10k, where X is the wavelength used for the fabrication.

7. The method of claim 1, wherein the smallest features within a printed structure are finished using the smallest possible voxel without any light structuring.

8. The method of claim 1, wherein voxel can be turned 360 degrees along the Z/optical axis depending on the required translation direction.

9. The method of claim 1, wherein voxel elongation can be either symmetrical in relation to optical axis or elongated to only one side.

10. The method of claim 1, wherein voxel is elongated at an angle to the translation direction at an angle a, which can be from 0 to 360 degrees.

11. The method of claim 1, wherein printing is carried out by using slicing and hatching procedure.

12. The method of claim 1, wherein applicable mask, exact width of the voxel and its movements are being generated by software based on the Gerchberg-Saxton algorithm.

13. A system for elongating voxel according to the method of claim 1, comprising:
a femtosecond laser source based multiphoton setup to emit ultrashort pulse with duration from 40 fs to 10 ps, repetition rate from 1 kHz to 500 MHz, wavelength from 380 nm to 2000 nm and diameter—from 1 mm to 10 mm;
a power attenuator to adjust the power of laser beam;
a polarization control optic to align the electric field of the light in a specific direction;
a telescope to adjust the size of the beam so that it matches the size of the beam shaping element or the matrix size of the device;
a beam shaping element to generate masks for volume filling to each translation during fabrication resulting in elongated voxel in focal plane of focusing element a focusing element for focusing the beam onto the focal plane.

14. The system of claim 13, wherein the beam shaping element selected of the group comprising of:
d) Spatial light modulator (SLM);
e) Diffractive optical element (DOE);
f) Dynamic mirror device (DMD).

15. The system of claim 13, wherein the focusing element numerical aperture is from 0.1 to 1.45.
